(19) United States
(12) Patent Application Publication
(10) Pub. No.: US 2004/0158464 A1
(43) Pub. Date: Aug. 12, 2004

(54) System and method for priority queue searches from multiple bottom-up detected starting points

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/360,915

(22) Filed: Feb. 10, 2003

(51) Int. Cl. G10L 15/00

(52) U.S. Cl. 704/231

(57) ABSTRACT

A speech recognition system includes an input unit configured to receive a sequence of acoustic observations. The system also includes a target pattern detecting unit configured to detect whether at least one of a set of prescribed patterns occurs in the sequence of acoustic observations, and for outputting a target detection signal as a result thereof. The system further includes a priority queue search unit configured to receive the target detection signal as output by the target pattern detecting unit, to separate the sequence of acoustic observations into subsequences of acoustic observations separated by the at least one prescribed pattern, and to include an entry in a priority queue for each of the subsequences. The priority queue search unit is configured to determine whether or not one beam of nodes corresponding to one entry in the priority queue can be joined with another beam of nodes corresponding to another entry in the priority queue. If the joining can be done, speech recognition information for the one beam is joined with speech recognition information from the another beam, to be used as a combined beam to be input as one entry in the priority queue.

### DESCRIPTION OF THE RELATED ART

In a large vocabulary speech recognition system, it is necessary to search the space of all possible sentences to find the word sequence that best matches the acoustic observations. One of the leading techniques for performing this search is a priority queue search in which the hypotheses being evaluated during the search are organized into a priority queue which is sorted according to a measure of the degree of match between each hypothesis and the acoustic observations. Although a priority queue search works well, it requires a large amount of computation. Furthermore, techniques for reducing the amount of computation often introduce errors in the speech recognition.

The present invention is directed to overcoming or at least reducing the effects of one or more of the problems set forth above.

### SUMMARY OF THE INVENTION

According to one embodiment of the invention, there is provided a speech recognition method, which includes receiving a sequence of acoustic observations. The method also includes detecting each occurrence of a set of prescribed patterns that occurs in the sequence of acoustic observations. Based on the detecting result, the method further includes setting an anchor for each of the set of prescribed patterns detected, and splitting up the sequence of acoustic observations into separate portions separated by the anchor. The method still further includes performing a priority queue search based on respective entries in a priority queue for each of the separate portions. The method also includes determining whether or not one beam corresponding to one of the separate portions can be joined with another beam corresponding to another of the separate portions. If the determination is that joining can be done, the method includes joining speech recognition information for the one beam with speech recognition information from the another beam, to be used as a combined beam for speech recognition processing to be performed by way of the priority queue search.

According to another embodiment of the invention, there is provided a speech recognition system, which includes an input unit configured to receive a sequence of acoustic observations. The system also includes a target pattern detecting unit configured to detect whether at least one of a set of prescribed patterns occurs in the sequence of acoustic observations, and for outputting a target detection signal as a result thereof. The system further includes a priority queue search unit configured to receive the target detection signal as output by the target pattern detecting unit, to separate the sequence of acoustic observations into subsequences of acoustic observations separated by the at least one prescribed pattern, and to include an entry in a priority queue for each of the subsequences. The priority queue search unit is configured to determine whether or not one beam of nodes corresponding to one entry in the priority queue can be joined with another beam of nodes corresponding to another entry in the priority queue. If the joining can be done, speech recognition information for the one beam is joined with speech recognition information from the another beam, to be used as a combined beam to be input as one entry in the priority queue.

According to yet another embodiment of the invention, there is provided a program product having machine-readable program code for performing speech recognition, the program code, when executed, causing a machine to perform the step of receiving a sequence of acoustic observations. The program code also causes the machine to perform the step of detecting each occurrence of a set of prescribed patterns that occurs in the sequence of acoustic observations, Based on the detecting result, the program code further causes the machine to perform the step of setting an anchor for each of the set of prescribed patterns detected, and splitting up the sequence of acoustic observations into separate portions separated by the anchor. The program code also causes the machine to perform the step of performing a priority queue search based on respective entries in a priority queue for each of the separate portions. The program code further causes the machine to perform the step of determining whether or not one beam corresponding to one of the separate portions can be joined with another beam corresponding to another of the separate portions. If the determination is that joining can be done, the program code causes the machine to perform the step of joining speech recognition information for the one beam with speech recognition information from the another beam, to be used as a combined beam for speech recognition processing to be performed by way of the priority queue search.

### BRIEF DESCRIPTION OF THE DRAWINGS

The foregoing advantages and features of the invention will become apparent upon reference to the following detailed description and the accompanying drawings, of which:

FIG. 1 is a block diagram of the system which multi-tasks target detection and multi-point priority queue search;

FIG. 2 is a flow chart of a target detection computation performed by a target detection computation unit according to at least one embodiment of the invention;

FIG. 3 is a flow chart of a multi-point priority queue search performed by a priority queue search unit according to at least one embodiment of the invention;

FIG. 4 shows the separation of a sequence of acoustic observations about an anchor or target, according to at least one embodiment of the invention;

FIG. 5 shows the combining of respective beams from two subsequences of a sequence of acoustic observations, to form a combined beam, to be used by the priority queue search unit according to at least one embodiment of the invention;

FIG. 6 is a flow chart of one possible computation performed by a multi-tasking control unit according to at least one embodiment of the invention, which is used to allocate computer time between the tasks of target detection and priority queue search; and

FIG. 7 is a flow chart of a speech recognition search process according to another embodiment of the invention, which separates a sequence of acoustic observations about one or more anchors or targets.

### DETAILED DESCRIPTION OF SPECIFIC EMBODIMENTS

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above are also be included within the scope of computer-readable media. Computer-executable instructions comprise, for example, instructions and data which cause a general purpose computer, special purpose computer, or special purpose processing device to perform a certain function or group of functions.

The invention will be described in the general context of method steps which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic:hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

The following terms may be used in the description of the invention and include new terms and terms that are given special meanings.

“Linguistic element” is a unit of written or spoken language.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval.

“Priority queue” in a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Best first search” is a search method in which at each step of the search process one or more of the hypotheses from among those with estimated evaluations at or near the best found so far are chosen for further analysis.

“Breadth-first search” is a search method in which at each step of the search process many hypotheses are extended for further evaluation. A strict breadth-first search would always extend all shorter hypotheses before extending any longer hypotheses. In speech recognition whether one hypothesis is “shorter” than another (for determining the order of evaluation in a breadth-first search) is often determined by the estimated ending time of each hypothesis in the acoustic observation sequence. The frame-synchronous beam search is a form of breadth-first search, as is the multi-stack decoder.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Frame synchronous beam search” is a search method which proceeds frame-by-frame. Each active hypothesis is evaluated for a particular frame before proceeding to the next frame. The frames may be processed either forwards in time or backwards. Periodically, usually once per frame, the evaluated hypotheses are compared with some acceptance criterion. Only those hypotheses with evaluations better than some threshold are kept active. The beam consists of the set of active hypotheses.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Branch and bound search” is a class of search algorithms based on the branch and bound algorithm. In the branch and bound algorithm the hypotheses are organized as a tree. For each branch at each branch point, a bound is computed for the best score on the subtree of paths that use that branch. That bound is compared with a best score that has already been found for some path not in the subtree from that branch. If the other path is already better than the bound for the subtree, then the subtree may be dropped from further consideration. A branch and bound algorithm may be used to do an admissible A* search. More generally, a branch and bound type algorithm might use an approximate bound rather than a guaranteed bound, in which case the branch and bound algorithm would not be admissible. In fact for practical reasons, it is usually necessary to use a non-admissible bound just as it is usually necessary to do beam pruning. One implementation of a branch and bound search of the tree of possible sentences uses a priority queue and thus is equivalent to a type of stack decoder, using the bounds as look-ahead scores.

“Admissible A* search.” The term A* search is used not just in speech recognition but also to searches in a broader range of tasks in artificial intelligence and computer science. The A* search algorithm is a form of best first search that generally includes a look-ahead term that is either an estimate or a bound on the score portion of the data that has not yet been scored. Thus the A* algorithm is a form of priority queue search. If the look-ahead term is a rigorous bound (making the procedure “admissible”), then once the A* algorithm has found a complete path, it is guaranteed to be the best path. Thus an admissible A* algorithm is an instance of the branch and bound algorithm.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic, programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time-align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Sum of paths match” is a process of computing a match between a network or a sequence of models and a sequence of acoustic observations in which, at each node at each point in the acoustic sequence, the cumulative score for the node is based on adding the probabilities of all the paths that lead to that node at that point in the acoustic sequence. The sum of paths scores in some examples may be computed by a dynamic programming computation that is sometimes called the forward-backward algorithm (actually, only the forward pass is needed for computing the match score) because it is used as the forward pass in training hidden Markov models with the Baum-Welch algorithm.

“Hypothesis” is a hypothetical proposition partially or completely specifying the values for some set of speech elements. Thus, a hypothesis is typically a sequence or a combination of sequences of speech elements. Corresponding to any hypothesis is a sequence of models that represent the speech elements. Thus, a match score for any hypothesis against a given set of acoustic observations, in some embodiments, is actually a match score for the concatenation of the models for the speech elements in the hypothesis.

“Look-ahead” is the use of information from a new interval of speech that has not-yet been explicitly included in the evaluation of a hypothesis. Such information is available during a search process if the search process is delayed relative to the speech signal or in later passes of multi-pass recognition. Look-ahead information can be used, for example, to better estimate how well the continuations of a particular hypothesis are expected to match against the observations in the new interval of speech. Look-ahead information may be used for at least two distinct purposes. One use of look-ahead information is for making a better comparison between hypotheses in deciding whether to prune the poorer scoring hypothesis. For this purpose, the hypotheses being compared might be of the same length and this form of look-ahead information could even be used in a frame-synchronous beam search. A different use of look-ahead information is for making a better comparison between hypotheses in sorting a priority queue. When the two hypotheses are of different length (that is, they have been matched against a different number of acoustic observations), the look-ahead information is also referred to as missing piece evaluation since it estimates the score for the interval of acoustic observations that have not been matched for the shorter hypothesis.

“Missing piece evaluation” is an estimate of the match score that the best continuation of a particular hypothesis is expected to achieve on an interval of acoustic observations that was yet not matched in the interval of acoustic observations that have been matched against the hypothesis itself. For admissible A* algorithms or branch and bound algorithms, a bound on the best possible score on the unmatched interval may be used rather than an estimate of the expected score.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Phoneme” is a single unit of sound in spoken language, roughly corresponding to a letter in written language.

“Phonetic label” is the label generated by a speech recognition system indicating the recognition system's choice as to the sound occurring during a particular speech interval. Often the alphabet of potential phonetic labels is chosen to be the same as the alphabet of phonemes, but there is no requirement that they be the same. Some systems may distinguish between phonemes or phonemic labels on the one hand and phones or phonetic labels on the other hand. Strictly speaking, a phoneme is a linguistic abstraction. The sound labels that represent how a word is supposed to be pronounced, such as those taken from a dictionary, are phonemic labels. The sound labels that represent how a particular instance of a word is spoken by a particular speaker are phonetic labels. The two concepts, however, are intermixed and some systems make no distinction between them.

“Spotting” is the process of detecting an instance of a speech element or sequence of speech elements by directly detecting an instance of a good match between the model(s) for the speech element(s) and the acoustic observations in an interval of speech without necessarily first recognizing one or more of the adjacent speech elements.

“Pruning” is the act of making one or more active hypotheses inactive based on the evaluation of the hypotheses. Pruning may be based on either the absolute evaluation of a hypothesis or on the relative evaluation of the hypothesis compared to the evaluation of some other hypothesis.

“Pruning threshold” is a numerical criterion for making decisions of which hypotheses to prune among a specific set of hypotheses.

“Pruning margin” is a numerical difference that may be used to set a pruning threshold. For example, the pruning threshold may be set to prune all hypotheses in a specified set that are evaluated as worse than a particular hypothesis by more than the pruning margin. The best hypothesis in the specified set that has been found so far at a particular stage of the analysis or search may be used as the particular hypothesis on which to base the pruning margin.

“Beam width” is the pruning margin in a beam search system. In a beam search, the beam width or pruning margin often sets the pruning threshold relative to the best scoring active hypothesis as evaluated in the previous frame.

“Best found so far.” Pruning and search decisions may be based on the best hypothesis found so far. This phrase refers to the hypothesis that has the best evaluation that has been found so far at a particular point in the recognition process. In a priority queue search, for example, decisions may be made relative to the best hypothesis that has been found so far even though it is possible that a better hypothesis will be found later in the recognition process. For pruning purposes, hypotheses are usually compared with other hypotheses that have been evaluated on the same number of frames or, perhaps, to the previous or following frame. In sorting a priority queue, however, it is often necessary to compare hypotheses that have been evaluated on different numbers of frames. In this case, in deciding which of two hypotheses is better, it is necessary to take account of the difference in frames that have been evaluated, for example by estimating the match evaluation that is expected on the portion that is different or possibly by normalizing for the number of frames that have been evaluated. Thus, in some systems, the interpretation of best found so far may be based on a score that includes a look-ahead score or a missing piece evaluation.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector-quantizer as used in speech compression or the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates.

“Language model” is a model for generating a sequence of linguistic elements subject to a grammar or to a statistical model for the probability of a particular linguistic element given the values of zero or more of the linguistic elements of context for the particular speech element.

“General Language Model” may be either a pure statistical language model, that is, a language model that includes no explicit grammar, or a grammar-based language model that includes an explicit grammar and may also have a statistical component.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Stochastic grammar” is a grammar that also includes a model of the probability of each legal sequence of linguistic elements.

“Pure statistical language model” is a statistical language model that has no grammatical component. In a pure statistical language model, generally every possible sequence of linguistic elements will have a non-zero probability.

“Entropy” is an information theoretic measure of the amount of information in a probability distribution or the associated random variables. It is generally given by the formula

E=Σᵢ pᵢ log(pᵢ), where the logarithm is taken base 2 and the entropy is measured in bits.

“Perplexity” is a measure of the degree of branchiness of a grammar or language model, including the effect of non-uniform probability distributions. In some embodiments it is 2 raised to the power of the entropy. It is measured in units of active vocabulary size and in a simple grammar in which every word is legal in all contexts and the words are equally likely, the perplexity will equal the vocabulary size. When the size of the active vocabulary varies, the perplexity is like a geometric mean rather than an arithmetic mean.

“Decision Tree Question” in a decision tree, is a partition of the set of possible input data to be classified. A binary question partitions the input data into a set and its complement. In a binary decision tree, each node is associated with a binary question.

“Classification Task” in a classification system is a partition of a set of target classes.

“Hash function” is a function that maps a set of objects into the range of integers {0, 1, . . . , N-1}. A hash function in some embodiments is designed to distribute the objects uniformly and apparently randomly across the designated range of integers. The set of objects is often the set of strings or sequences in a given alphabet.

“Lexical retrieval and prefiltering.” Lexical retrieval is a process of computing an estimate of which words, or other speech elements, in a vocabulary or list of such elements are likely to match the observations in a speech interval starting at a particular time. Lexical prefiltering comprises using the estimates from lexical retrieval to select a relatively small subset of the vocabulary as candidates for further analysis. Retrieval and prefiltering may also be applied to a set of sequences of speech elements, such as a set of phrases. Because it may be used as a fast means to evaluate and eliminate most of a large list of words, lexical retrieval and prefiltering, is sometimes called “fast match” or “rapid match”.

“Pass.” A simple speech recognition system performs the search and evaluation process in one pass, usually proceeding generally from left to right, that is, from the beginning of the sentence to the end. A multi-pass recognition system performs multiple passes in which each pass includes a search and evaluation process similar to the complete recognition process of a one-pass recognition system. In a multi-pass recognition system, the second pass may, but is not required to be, performed backwards in time. In a multi-pass system, the results of earlier recognition passes may be used to supply look-ahead information for later passes.

The present invention according to at least one embodiment described below uses a form of priority queue search in which the search does not proceed in a left-to-right fashion, but rather proceeds out from hypotheses located at several different points in the speech interval being recognized. The candidates for hypotheses at new points in the speech interval are supplied by a target detection computation that runs in parallel, multi-tasked with the priority queue search computation. By having hypotheses supplied by the target detector in the middle of the speech interval, for example, the priority queue search is able to recover from pruning errors and also to avoid getting stuck using too much computation exploring many alternative hypotheses for a shorter interval of speech and thus never finding better hypotheses in a longer speech interval.

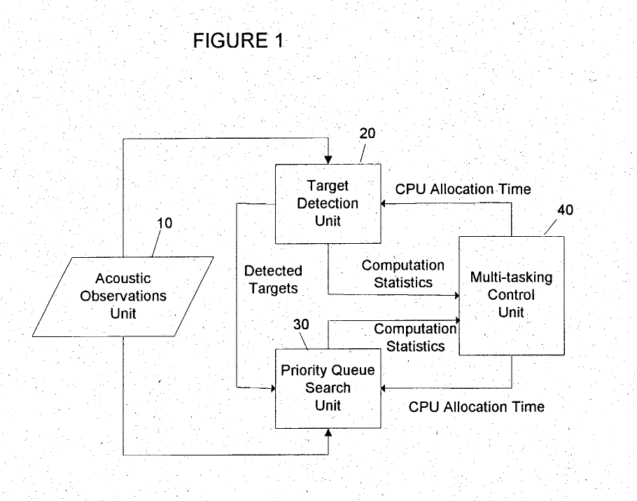

Referring now to FIG. 1, Acoustic Observation Input Unit 10 obtains acoustic observations and supplies them to both the target detection computation in Target Detection Unit 20 and the priority queue search in Priority Queue Search Unit 30. The acoustic observations, for example, may be labels from a finite alphabet obtained, in one embodiment, from a phonetic recognizer or may be continuous observations measurements obtained, for example, from a time-frequency spectral analysis of the speech signal.

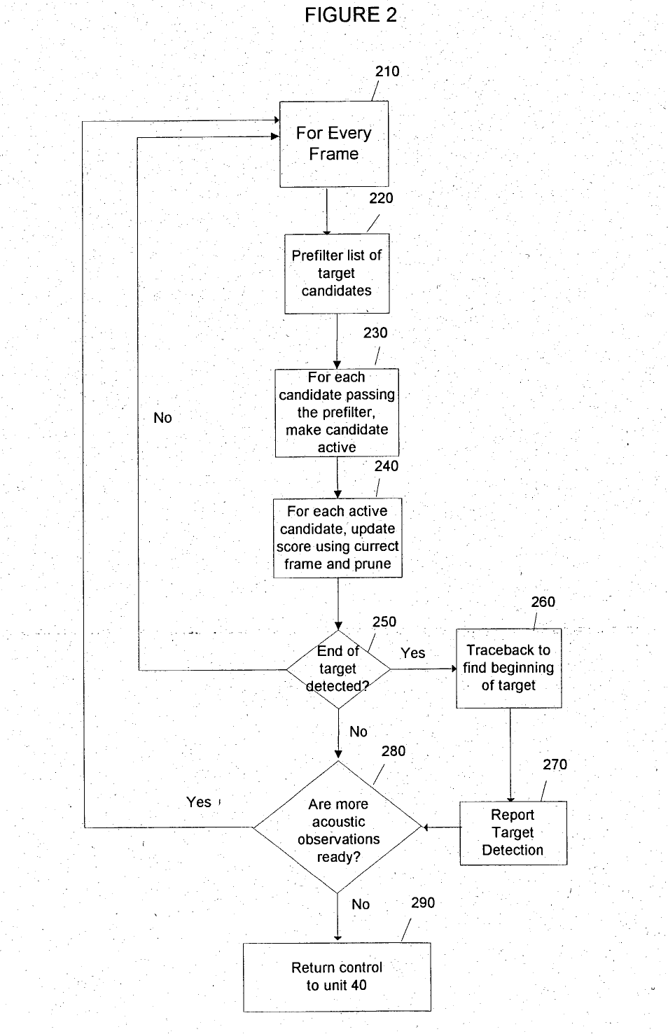

Target Detection Unit 20 detects instances of one or more targets, as described more fully with reference to FIG. 2. Each target is a speech element or a sequence of speech elements. In one embodiment, for example, a list of targets may include a plurality of words from a vocabulary. In another embodiment, the targets include sequences of phonemes, where each sequence of phonemes may be a subsequence of the phonemes in a word or may be a phoneme sequence that spans a boundary between words. In yet another embodiment, a target may include syllables or sequences of syllables. In yet another embodiment, a target may include phrases with one or more words in each phrase.

In an embodiment, the detection in Target Detection Unit 20 runs continuously, looking for instances of targets that might occur at any time in the speech interval. In one embodiment, it runs in parallel, multi-tasked with the priority queue search computation performed by the Priority Queue Search Unit 30. When the Target Detection Computation Unit 20 detects an instance of a target, it sends a signal to the Priority Queue Search Unit 30 to indicate the detection of the target.

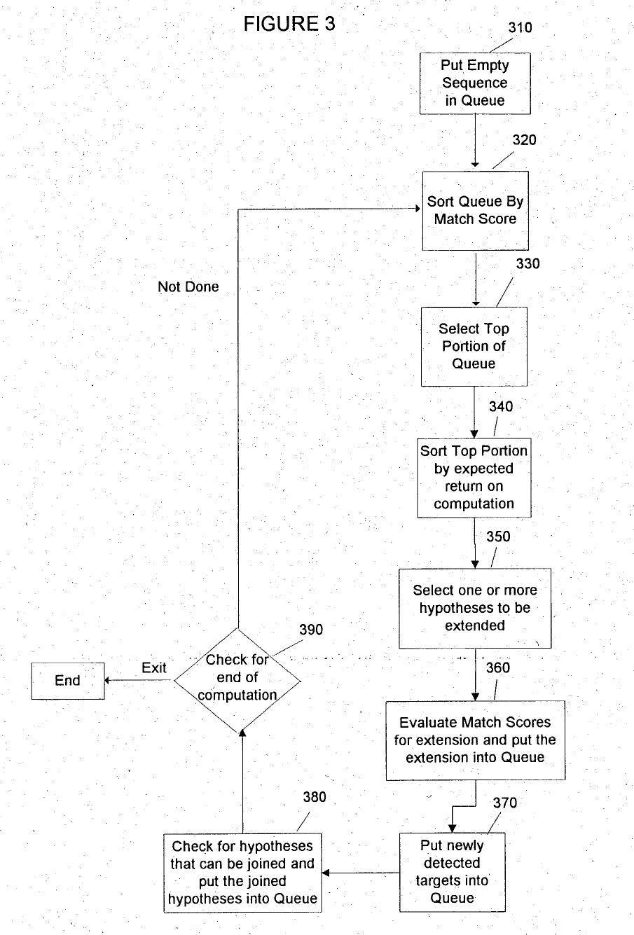

The Priority Queue Search Unit 30 performs a priority queue search computation, as described more fully with reference to FIG. 3. The priority queue used in the Priority Queue Search Unit 30 organizes, into a single priority queue, hypotheses that represent different portions of the, speech interval that might or might not overlap. When a hypothesis is extended, the addition to the hypothesis and the match computation against acoustic observations might extend the hypothesis in either direction. That is, the additional acoustic observations matched in the extension might either be added from the speech time interval before the beginning of the hypothesis or be added from the speech, time interval after the ending of the hypothesis.

Multi-tasking Control Unit 40 controls the allocation of computer time to tasks performed by the Target Detection Unit 20 and the tasks performed by the Priority Queue Search Unit 30. The Target Detection Unit 20 and the Priority Queue Search Unit 30 both send computation statistics to the Multi-tasking Control Unit 40, which the Multi-tasking Control Unit 40 utilizes in determining an amount of CPU time to allocate to these two units. By way of example and not by way of limitation, the computation statistics report the percentage completion of the reporting module on the acoustic observations that have been received so far. The Multi-tasking Control Unit 40 uses these statistics to estimate whether allocation of an additional fraction of the computer time to one of the units 20, 30 is likely to improve the performance and efficiency of the overall system.

Referring now to FIG. 2, an embodiment is described for the detection of target events. In this embodiment, the target detection (performed by the Target Detection Unit 20 shown in FIG. 1) runs continuously, processing the acoustic observations frame-by-frame. Other orders of evaluation are feasible. For example, in another embodiment, the target detection computation could use a priority queue. In other embodiments, the targets could be detected by other means that are well known to those skilled in the art of pattern detection, such as by using neural networks or decision trees.

In the embodiment shown via a flow chart FIG. 2, Block 210 controls a loop that runs frame-by-frame through the acoustic observation sequence.

For each frame, Block 220 performs a prefiltering computation such as is well-known to those skilled in the art of large vocabulary speech recognition. A prefiltering computation is a relatively fast approximate computation that selects, from a large list of potential candidates, a smaller list of candidates on which to perform a more computationally expensive and more exact computation.

For each target candidate that passes through the prefiltering operation, Block 230 makes the candidate active, if it isn't already active. It also initializes the first node of the network for the target with a start score that represents the hypothesis that an instance of the target is beginning at the current frame.

Block 240 updates the score for each active candidate target. The active candidates include those that have been made active by Block 230 in the current frame, as well as those that were made active in some previous frame and which have not yet been pruned and made inactive. In one embodiment, Block 240 updates the score for each active candidate by a dynamic programming computation to match the model for the candidate to the observed-acoustics, which is a computation that is well-known to those skilled in the art of speech recognition.

Block 240 also compares the match scores for each active candidate with a pruning threshold to determine when to prune the candidate and make it inactive. A candidate will be pruned when it accumulates multiple frames of poor match scores against the acoustic observations. A candidate will also be pruned when the acoustics frames get beyond the end of the target so that the target no longer matches well against subsequent frames.

Block 250 checks to see if the end of the target has been detected. In one embodiment, Block 250 checks to see if the accumulated match score from the dynamic programming match has a score for the final node of the network representing the target such that the score for that final node is, better than an acceptance threshold and that the node has not been pruned.

If Block 250 reports that the end of a target has been detected because, for example, the score for the final node is better than the acceptance threshold, then Block 260 performs a traceback computation to find the best beginning time for the target. This traceback computation is well-known to those skilled in the art of computing match scores using dynamic programming.

Block 270 then reports the detection of a target to the Priority Queue Search Unit 30 shown in FIG. 1, together with its score and beginning and ending time.

Block 280 checks to see if more acoustic observations are ready. If not, it returns control in Block 290 to the Multi-tasking Control Unit 40 shown in FIG. 1, and waits for more data to become available. If more data is available, then Block 280 returns control to Block 210 to start the loop for the next frame.

Referring now to FIG. 3, one embodiment of the multi-point priority queue search performed by the Priority Queue Search Unit 30 is described in the form of a flow chart. In this embodiment, a single priority queue is created to hold hypotheses that start at different points in speech time and hypotheses that may be extended either forward in time or backward in time.

Block 310 initializes the queue by putting into the queue the hypothesis that corresponds to an empty sequence at the beginning of the speech interval. This hypothesis will be extended in Block 350 to create the hypotheses that match initial portions of the speech interval being recognized.

Block 320 sorts the queue using the match score for each hypothesis. The match score for each hypothesis is a measure of how well the hypothesis matches the acoustic observations. These scores that are computed incrementally by Block 360 as new speech elements are added to extend an existing hypothesis. In one embodiment, Block 320 sorts the queue by comparing a given hypothesis score against the best scoring hypothesis that overlaps the given hypothesis by at least a specified amount in an overlapping time interval. The queue is then sorted according to these differences in score relative to the best scoring hypotheses, whereby lower scoring hypotheses that overlap a higher scoring hypothesis by at least the specified amount are dropped out from the top portion of the priority queue. This relative scoring has the desirable property that any hypothesis which is the only hypothesis in a given time interval will be placed among the hypotheses at the top portion of the priority queue.

Block 330 selects a number of hypotheses forming the top portion of the priority queue. Note that in this embodiment of a multi-point priority queue, the queue may simultaneously contain many hypotheses each of which is a correct transcription for a different portion of the speech interval. The purpose of this selection is to select a portion of the priority queue that contains mostly such correct hypotheses and that contains most of the correct hypotheses. By way of example and not by way of limitation, the top portion of the priority queue may correspond to the top ten (10) or top one hundred (100) hypotheses in the priority queue.

Block 340 sorts the top portion of the priority queue according to an estimate for each given hypothesis of the expected return on computation in terms of productive information obtained if the hypothesis is extended. Because the selected top portion of the priority queue is intended to contain many hypotheses that correspond to correct transcriptions, but at different portions of the speech interval, the selection of which hypotheses to extend at this stage in the computation in this embodiment will not be based on the match score. If two hypotheses are both correct transcriptions, but for different portions of speech, their match scores do not provide the most useful information for determining which hypothesis will be the most productive to extend.

In one embodiment, Block 340 estimates the amount of productive information that the extension of a given hypothesis might provide by performing a computation utilizing: a) the total size of the speech interval covered by the hypothesis, together with b) the size of the next speech interval that has already been analyzed that is in the direction of the hypothesized extension and that potentially might be joined with the given hypothesis. In one embodiment, this estimate of the amount of productive information is divided by an estimate of the amount of computation that will be required to get that information. By way of example and not by way of limitation, the estimate of the amount of computation is the product of an estimated branching factor times the size of the gap between the interval covered by the given hypothesis and the next interval to which the given hypothesis might be joined. The estimate of the branching factor for the hypothesis is based on restrictions from the grammar and from either forward or backward prefiltering at the point in speech time at which the hypothesis is being extended. The grammar and the prefiltering restrict the number of viable extension hypotheses. The number of such, extension hypotheses is used in one embodiment as one factor in the estimate of the amount of computation that will be required to fill the gap.

Thus, by way of example and not by way of limitation, a formula for the estimated productive value of extending hypothesis H backwards towards an earlier time interval in which hypothesis G is the best hypothesis would be

Productive Value=[(T2(H)−T1(H))+(T2(G)−T1(G))]/[(T1(H)−T2(G))*B1(H)],

where T1(H) and T1(G) are the estimated starting times of H and G respectively,

T2(H) and T2(G) are the estimated ending times of H and G respectively, and B1(H) is the estimated average branching factor to be encountered in extending hypothesis H backwards towards G.

A similar formula could be used if H were to be extended to a G which starts at a later time. B1(H) would be the minimum of the number of extensions of H (in the designated direction) allowed by the grammar (or by a statistical language model) and the expected number of extensions that would be accepted by acoustic-based prefiltering. If the grammar or language model allows almost all word sequences (in particular for a statistical n-gram language model), B1(H) would depend mainly on the computation reduction from prefiltering rather than grammatical restriction, in which case one embodiment would be to use a constant B1 which could then be dropped, since the same constant would be used for all the hypotheses being compared.

In one embodiment, in the forming of the top portion of the priority queue, each hypothesis is split so that each split hypothesis encompasses not only a hypothesis of a sequence of speech elements that match against a given interval of acoustic observations, but also a designated direction in which the hypothesis is to be extended. Thus, the top portion queue will generally contain two entries for each hypothesized sequence of speech elements. These two queue entries are linked so that when one of them is extended, the other member of the pair is updated to reflect the extension. The evaluation of the expected return on computation is estimated separately for each of the two entries corresponding to the split hypothesis, so they will appear at different places in the priority queue after the sort by expected return on computation.

Block 350 selects one or more hypotheses from at or near the top of the priority queue (but still within the top portion of the priority queue), as sorted by expected return on computation. In one embodiment, more than one hypothesis may be selected to be extended because there are multiple hypotheses that might correspond to correct transcriptions and it may be more efficient to compute their extension together rather than one at a time.

Block 360 evaluates the match scores of the extensions to the hypotheses selected to be extended. As noted, in one embodiment, for each hypothesis to be extended, the extensions are restricted by the grammar and by either forward or backward prefiltering at the point in the speech interval at which the hypothesis is being extended. In one example implementation, the match score for each extension is computed by a dynamic programming computation in a manner using any convenient speech recognition method. As the match score for each extension is computed, the extension having the best match score is combined with the hypothesis to create an extended hypothesis, and the extended hypothesis is put into the priority queue in its proper position.

Block 370 puts into the priority queue the hypotheses that correspond to targets that have been newly detected and reported by the Target Detection Computation Unit 20 (shown in FIG. 1) since the last cycle of hypothesis extensions in the priority queue search.

Block 380 checks for intersection among the hypotheses, including the new hypotheses that have been put in the queue by the extension evaluation in Block 360 and the newly detected targets put into the queue by, Block 370. In this embodiment, two hypotheses are said to intersect if they either overlap in speech * time (the speech “time” of a given hypothesis is the range of frames from the estimated beginning of the hypothesis to the estimated ending of the hypothesis, where each frame may be either a constant duration in clock time, or may be a data-dependent interval such as the time interval of the acoustic segment determined by a phonetic recognizer) with consistent speech elements in the overlap portion, or if they abut or nearly abut in speech time and there is overlap in the states of the network that are active in each hypothesis at the abutting times. (A particular state is “active” in a given hypothesis at a given time if it is a state in the model network for the given hypothesis extension that was evaluated for match at the given speech time and if the particular state was not been pruned, for example due to a beam pruning within a dynamic programming match computation.) In one possible embodiment, only states that are initial or final states of their hypotheses would be checked for overlap. In this embodiment, hypotheses would be joined only at the beginnings or endings of full speech elements. When two hypotheses intersect, they are joined into a single hypothesis with the concatenation or union of their sequences of speech elements. The joined hypothesis is then put into the priority queue.

Block 390 checks to see if a completion criterion is met. In one embodiment, the completion criterion checks whether there are one or more hypotheses that represent complete “sentences” as that term is defined herein. If there are one or more complete sentence hypotheses, the completion criterion compares the best partial sentence hypotheses with the best complete sentence hypothesis to estimate the likelihood that continued computation will find a better scoring complete sentence hypothesis. In one embodiment, for near real-time interactive applications, the completion criterion also checks against a time-out interval that starts at the detection of the end of the utterance to impose an upper bound on the response time. In one implementation, there is a shorter time out period that is used if at least one complete sentence hypothesis has been found and a longer time out period if no complete sentence has been found. If no complete sentence hypothesis has been found at the expiration of the longer time out period, this embodiment would put out an utterance rejection message or ask the user to repeat the utterance or ask for clarification.

If the completion criterion has not been met, the computation is continued again at Block 320.

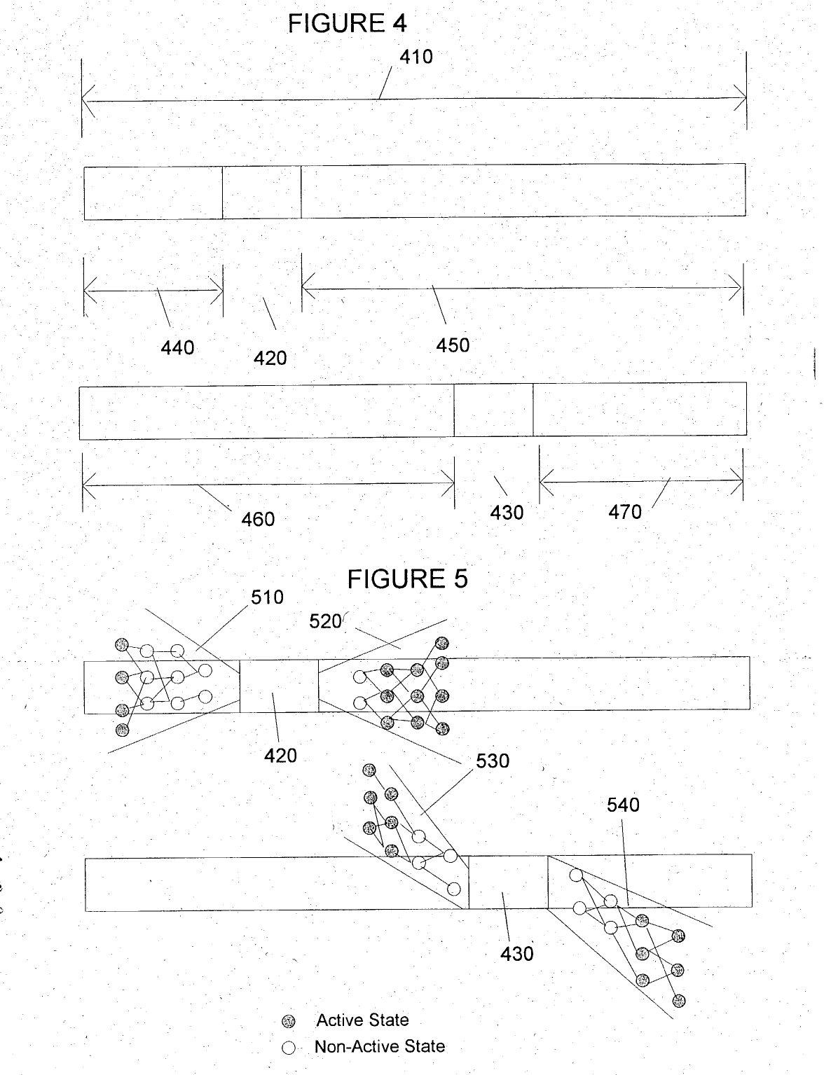

The process of combining more than one partial sentence hypothesis is explained below with reference to FIGS. 4 and 5. By way of example and not by way of limitation, turning now to FIG. 4, a sequence of acoustic observations 410 is shown, whereby a first pattern 420 in the set of patterns is detected at a front end part of the sequence of acoustic observations 410, and whereby a second pattern 430 in the set of patterns is detected at a back end part of the sequence of acoustic observations 410. The first and second patterns are detected by the Target Detection Unit 20 shown in FIG. 1.

While a speech recognition process is being performed on the entire sequence of acoustic observations 410 utilizing the Priority Queue Search Unit 30 shown in FIG. 1, the sequence of acoustic observations 410 is split up into a first sequence of acoustic observations 440 that occurs before the start of the first pattern (or first target) 420, and a second sequence of acoustic observations 450 that exists after the end of the first pattern 420. Also, the sequence of acoustic observations 410 is split up into a third sequence of acoustic observations 460 that exists before the start of a second pattern (or second target) 430, and a fourth sequence of acoustic observations 470 that exists after the end of the second pattern 430. Note that the first and second sequences 440, 450 are separate from each other (no overlap), and the third and fourth sequences 460, 470 are separate from each other (no overlap), but whereby the same cannot be automatically said of the first sequence 440 with respect to the third and fourth sequences 460, 470, or the second sequence 450 with respect to the third and fourth sequences 460, 470, or the third sequence 460 with respect to the first and second sequences 440, 450, or the fourth sequence 470 with respect to the first and second sequences 440, 450.

As a separate speech recognition process is performed on the first, second, third and fourth sequences 440, 450, 460, 470 (that is, they have entries in the priority queue of the Priority Queue Search Unit 30 shown in FIG. 1), it is determined when any two of those searches going in opposite directions arrive at a same time interval with respect to the sequence of acoustic observations. If so, it is determined whether or not their results can be joined. By way of example, if the beam obtained for the speech recognition process for the third sequence 460 intersects the beam obtained for the speech recognition process for the first sequence 440, such as if their active nodes intersect at the same point in the sequence of acoustic observations, then those two beams are combined, or joined (e.g., concatenated), to form a combined beam.

More particularly, the results from two separate speech recognition processes (e.g., one proceeding in a forward direction and one proceeding in a backward direction) can be joined if their respective beams at a same point in time in a sequence of acoustic observations overlap with respect to the set of active states in each of the respective beams.

The results obtained by joining at least two of the beams are provided to the priority queue, which may cause the order of candidate partial speech, recognition results stored in the priority queue to change.

FIG. 5 shows a first beam 510 and a second beam 520 respectively extending from the start and the end of the first pattern 420, and a third beam 530 and a fourth beam 540 respectively extending from the start and the end of the second pattern 430, as obtained by performing separate speech recognition processings on the split sequence of acoustic observations. If the second beam 520 intersects with the third beam 530, and there are any active states (shown as shaded states in FIG. 5) in the second beam 520 that overlap any active states (shown as shaded states in FIG. 5) in the third beam 530 at a same point of time (e.g., same frame) of the sequence of acoustic observations, then the results of those two beam searches are combined, or joined. The same thing can be done for any of the beams that intersects with any of the other beams and that have overlapping active states at a particular point in time of the sequence of acoustic observations. FIG. 5 shows a case whereby the second beam 520 can be combined with the third beam 530 due to the overlap in at least some of their respective active states.

The present invention utilizes the detection of a particular pattern in the sequence of acoustic observations, as a target, whereby the confidence factor due to the detection of the particular pattern is very high. For example, if it is known beforehand that a speaker is speaking a phrase that includes a state name (e.g., “California” or “Hawaii”), then the set of particular patterns for a target would include the phoneme sequences for each of the fifty possible states, and when one of those particular patterns is found, the confidence factor that this is indeed a correct speech recognition is very high, and accordingly the chances are very high that this node would not be pruned in a speech recognition process, no matter how tight the pruning bound is.

Furthermore, knowledge obtained from a language model can be used to obtain a limited set of hypotheses for phonemes occurring just before and just after the detected pattern. For example, if a state name is the thing being detected, then it is likely that a zip code is spoken next (as part of a full address being spoken by a user), whereby the set of possible phonemes occurring just after the state name is a very limited set (phonemes for the beginning portions of the numbers 0 through 9 as spoken, for example). This information can be used to lessen the computations required for each of the separate speech recognitions performed, while not sacrificing much if at all in terms of the accuracy in the speech recognition obtained.

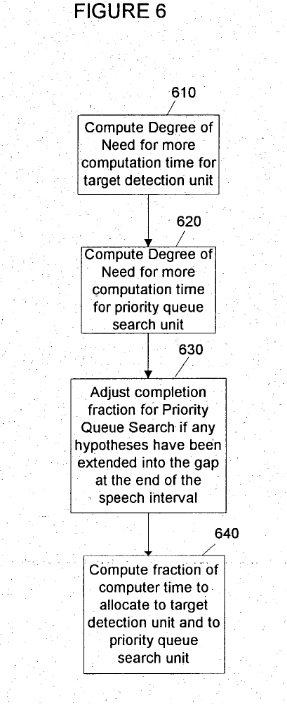

Referring now to FIG. 6, the allocation of computer time (determined by the Multi-tasking Control Unit 40 shown in FIG. 1) is described in more detail.

By way of example, Block 610 estimates the degree of completion of the target detection computation, FT, by computing a fraction of the speech interval up to the current frame that has been processed by the Target Detection Unit 20. The degree of need for more computation time for the Target Detection Unit 20 will then be inversely proportional to FT.

Let TD=time of frame currently being analyzed by the Target Detection Unit 20,

t=time of current frame

FT=TD/t

By way of example, Block 620 estimates the degree of completion of the priority queue computation, FQ, by computing the portion of hypotheses being evaluating in earlier portions of the speech interval with the portion of hypotheses being evaluated in later portions. The degree of need for more computation time by the Priority Queue Search Unit 30 will then be inversely proportional to FQ.

Let TQ=average time of the last N hypotheses to be extended

FQ=TQ/t

where N is a predetermined number of samples over which the moving average estimate is computed.

In one embodiment, Block 630 determines whether or not the CPU times need to be adjusted by checking whether any hypotheses in the priority queue have been extended into the gap at the end of the speech interval. That is, it determines whether or not any hypothesis has been extended to the right into a time interval that is later than the starting time of any other target that has been reported by the Target Detection Unit 20. If so, then Block 630 sets FQ to a value greater than 1, for example FQ=1.5, in order to give more CPU time to the Target Detection Unit 20. FD and FQ represent the fraction of computation that has already been completed by the Target Detection Unit 20 and the Priority Queue Search Unit 30, respectively. Therefore, when FQ is relatively large (e.g., close to or greater than one), then extra time is given to the Target Detection Unit 20.

Block 640 computes the fraction of computer time to allocate to the Target Detection Unit 20 and to the Priority Queue Search Unit 30 (shown in FIG. 1), so that the module which is most in need of extra computation is assisted in catching up. By way of example and not by way of limitation, in one embodiment, the value AD, which corresponds to the fraction of time allocated to the Target Detection Unit 20, could be assigned by way of the following equation:

AD=(1/FT)/((1/FT)+(1/FQ))

The value PD that corresponds to the fraction of time allocated to the Priority Queue Search Unit 30 is computed by the following equation:

PD=1−AD

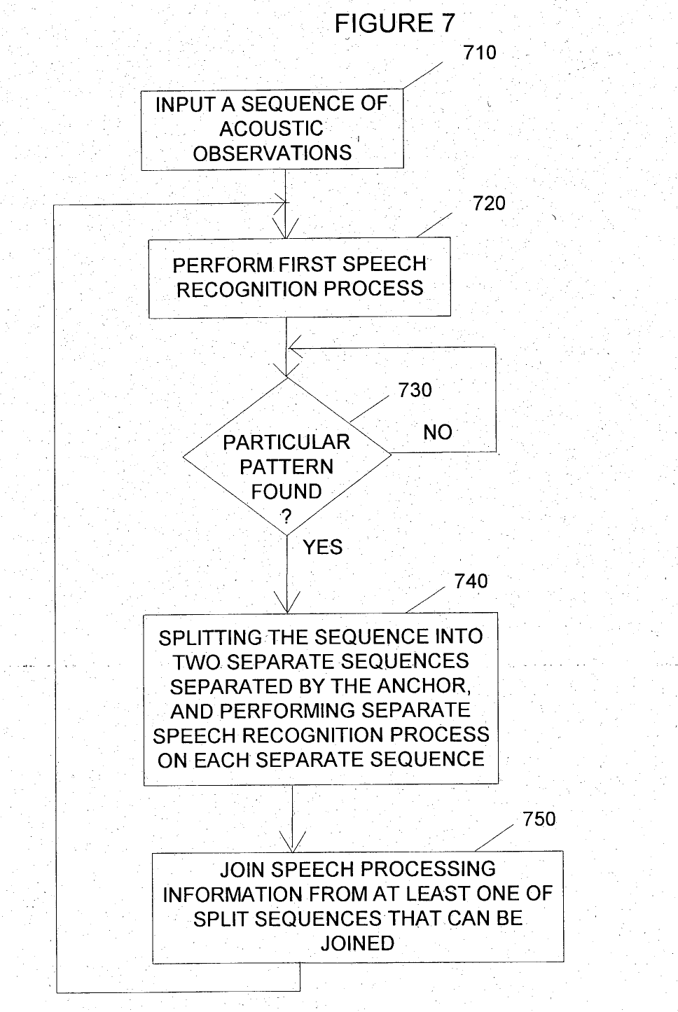

Another embodiment of the invention will be described below with reference to FIG. 7. In a first step 710, a sequence of acoustic observations are input. The sequence of acoustic observations may be a sequence of phonemes, as output by a phonetic recognizer, a sequence of words or phrases, or a frequency-analyzed portion of input speech, just to name some of the possibilities.

In a second step 720, a first speech recognition process is performed on the sequence of acoustic observations, such as by utilizing a conventional priority queue search speech recognition process, as is known to those skilled in the speech recognition art.

In a third step 730, at about the same time that the first speech recognition process is being performed, a determination is made as to whether or not one of a set of patterns of speech elements, such as a particular sequence of phonemes, is detected in the sequence of acoustic observations. The particular sequence of speech elements may be a particular multi-syllabic word, a particular sequence of words, or a particular sequence of phonemes, just to name a few of the possibilities.

If the determination made in the third step 730 is that one of the particular sequences of speech elements is found in the sequence of acoustic observations, then separate speech recognition processings are performed in step 740, whereby the particular sequence of speech elements corresponds to an anchor or target, and whereby the sequence of acoustic observations is split up into a first sequence of acoustic observations occurring before the occurrence of the anchor, and a second sequence of acoustic observations occurring after the occurrence of the anchor (see FIG. 4, for example).

Such a technique for performing two separate speech recognition processings about a target (referred to as an “anchor” in a co-pending patent application) is described in a co-pending patent application entitled “System and Method For Utilizing An Anchor To Reduce Memory Requirements For Speech Recognition”, Ser. No. 10/______, filed on Jan. 23, 2003, which is assigned to the same assignee as this application, and which is incorporated in its entirety herein by reference.

However, unlike the requirement in the above-referenced related application that the target be detected with a strong certainty, in this embodiment the target may be detected with a much lesser reliability factor. This is the case since the splitting up of an acoustic utterance by way of one or more targets is used as a supplement to a speech recognition processing being performed at the same time on the entire acoustic utterance, and thus any errors with respect to incorrectly identifying a target are not fatal to the combined speech recognition process (since the results obtained from an inaccurate detection of a target are not utilized to enhance the combined speech recognition process). In systems where computing and memory resources are plentiful, this does not pose a problem.

As explained above and in the related co-pending patent application, two separate searches of the split sequence of acoustic observations are performed, whereby one starts from the starting point of the target and works back in time to the beginning of the first split portion of the sequence of acoustic observations, and whereby the other starts from the ending point of the target and works forward in time to the end of the second split portion of the sequence of acoustic observations.

In accordance with an embodiment of the present invention, these two speech recognition processings are performed along with the speech recognition process that is performed in step 720 as shown in FIG. 7, and they effectively run substantially in parallel with the speech recognition process being performed in step 720.

By such a method and system, extra memory requirements and computational resources are required than would be required if just the speech recognition process in step 720 is being performed by itself. Thus, this embodiment as well as other embodiments described earlier are particularly suitable for a system that has an ample amount of computational and memory capability, such as a computer server on a network or a computer workstation.

In a fifth step 750, information obtained by way of the two separate speech recognition processings (performed in step 740) on the split sequence of acoustic observations, is provided to a combined speech recognition process, which includes information obtained from each separate speech recognition process, in order to enhance the speech recognition. For example, if the search being performed on one of the two split portions of the sequence of acoustic observations, results in a better search score than what was obtained for the same portion of the sequence of acoustic observations in step 720, then the speech recognition processing being performed in step 720 is modified so as to use the search results obtained from the speech recognition processing performed on one of the two split portions of the sequence of acoustic observations (e.g., the priority queue in step 720 is reordered based on the speech recognition information provided in step 750).

In one embodiment, for each time one of the set of patterns of speech elements is found in the sequence of acoustic observations, the sequence of acoustic observations is split up about a target, whereby the target corresponds to the one of the set of patterns that was detected.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “module” or “component” or “unit” as used herein and in the claims is intended to encompass implementations using one or more lines of software code, and/or hardware implementations, and/or equipment for receiving manual inputs.

The foregoing description of embodiments of the invention has been presented for purposes, of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A speech recognition method, comprising:
receiving a set of acoustic observations;
detecting, as a target, at least one occurrence of a set of prescribed patterns that occurs in the set of acoustic observations;
based on the detecting result, splitting up the sequence of acoustic observations into separate portions separated by the target; and
performing a priority queue search based on respective entries in a priority queue for a plurality of the separate portions.

2. The method as defined in claim 1, wherein the set of acoustic observations is a sequence of acoustic observations.

3. The method as defined in claim 1, further comprising:
determining whether or not one beam corresponding to one of the separate portions can be joined with another beam corresponding to another of the separate portions; and
if the determination is that joining can be done, joining speech recognition information for the one beam with speech recognition information from the another beam, to be used as a combined beam for speech recognition processing to be performed by way of the priority queue search.

4. The method as defined in claim 1, wherein the set of prescribed patterns corresponds to a particular word in the sequence of acoustic observations or a particular sequence of phonemes in the sequence of acoustic observations.

5. The method as defined in claim 1, further comprising:
during the speech recognition processing of at least one of the separate portions, determining a plurality of prefix nodes that could occur just before the target in the set of acoustic observations, and determining a plurality of suffix nodes that could occur just after the target in the set of acoustic observations.

6. The method as defined in claim 5, wherein the prefix nodes and the suffix nodes are determined based on a particular language model.

7. The method as defined in claim 1, further comprising:
periodically outputting computation statistics for detecting the prescribed patterns;
periodically outputting computation statistics for performing the priority queue search; and
allocating first processing time for detecting the prescribed patterns and second processing time for performing the priority queue search as a result thereof.

8. The method as defined in claim 7, wherein the first and second processing time is allocated with respect to a single processing unit.

9. A speech recognition system, comprising:
an input unit configured to receive a set of acoustic observations;
a target pattern detecting unit configured to detect whether at least one of a set of prescribed patterns occurs in the set of acoustic observations, and for outputting a target detection signal as a result thereof; and
a priority queue search unit configured to receive the target detection signal as output by the target pattern detecting unit, to separate the sequence of acoustic observations into subsets of acoustic observations separated by the at least one prescribed pattern, and to include an entry in a priority queue for each of the subsets.

10. The system as defined in claim 9, wherein the set of acoustic observations corresponds to a sequence of acoustic observations.

11. The system as defined in claim 9,
wherein the priority queue search unit is configured to determine whether or not one beam of nodes corresponding to one entry in the priority queue can be joined with another beam of nodes corresponding to another entry in the priority queue, and
wherein if the joining can be done, speech recognition information for the one beam is joined with speech recognition information from the another beam, to be used as a combined beam to be input as one entry in the priority queue.

12. The system as defined in claim 9, wherein the set of prescribed patterns includes at least one word or at least one sequence of phonemes or at least one pause of at least a predetermined duration.

13. The system as defined in claim 9, wherein each of the target pattern detection unit and the priority queue search unit is configured to output computation statistics, and wherein the system further comprises:
a multi-tasking control unit configured to receive the respective computation statistics output by the target pattern detection unit and the priority queue search unit, and to allocate processing time to the target pattern detection unit and the priority queue search unit as a result thereof.

14. The system as defined in claim 9, wherein the priority queue search unit is further configured to determine a plurality of prefix nodes that could occur just before the at least one prescribed pattern in the set of acoustic observations, and a plurality of suffix nodes that could occur just after the at least one prescribed pattern in the set of acoustic observations, and to extend hypotheses for corresponding entries in the priority queue accordingly.

15. The system as defined in claim 14, wherein the prefix nodes and the suffix nodes are determined based on a particular, language model.

16. A program product having machine-readable program code for performing speech recognition, the program code, when executed, causing a machine to perform the following steps:
receiving a set of acoustic observations;
detecting, as a target at least one occurrence of a set of prescribed patterns that occurs in the set of acoustic observations;
based on the detecting result, splitting up the set of acoustic observations into separate portions separated by the target; and
performing a priority queue search based on respective entries in a priority queue for each of the separate portions.

17. The program product as defined in claim 16, wherein the set of acoustic observations corresponds to a sequence of acoustic observations.

18. The program product as defined in claim 16, further comprising:
determining whether or not one beam corresponding to one of the separate portions can be joined with another beam corresponding to another of the separate portions; and
if the determination is that joining can be done, joining speech recognition information for the one beam with speech recognition information from the another beam, to be used as a combined beam for speech recognition processing to be performed by way of the priority queue search.

19. The program product as defined in claim 16, wherein the set of prescribed patterns corresponds to a particular word in the sequence of acoustic observations or a particular sequence of phonemes in the sequence of acoustic observations.

20. The program product as defined in claim 16, further comprising:
during the speech recognition processing of at least one of the separate portions, determining a plurality of prefix nodes that could occur just before the target in the set of acoustic observations, and determining a plurality of suffix nodes that could occur just after the target in the set of acoustic observations.

21. The program product as defined in claim 20, wherein the prefix nodes and the suffix nodes are determined based on a particular language model.

22. The program product as defined in claim 16, further comprising:
periodically outputting computation statistics for detecting the prescribed patterns;
periodically outputting computation statistics for performing the priority queue search; and
allocating a first processing time for detecting the prescribed patterns and a second processing time for performing the priority queue search as a result thereof.

23. The program product as defined in claim 22, wherein the first and second processing times are allocated with respect to a single processing unit.

24. A speech recognition method, comprising:
receiving a sequence of acoustic observations;
detecting at least one occurrence of a set of prescribed patterns occurs in the sequence of acoustic observations;
based on the detecting result, setting an anchor for each of the set of prescribed patterns detected, and splitting up the sequence of acoustic observations into separate portions separated by the anchor; and
performing a speech recognition processing on each of the separate portions, in parallel;
determining whether or not one beam corresponding to one of the speech recognition processings can be joined with another beam corresponding to another of the speech recognition processings; and
if the determination is that joining can be done, joining speech recognition information for the one beam with speech recognition information from the another beam, to be used as a combined beam for speech recognition processing to be performed on a remaining portion of the sequence of acoustic observations.

25. The method as defined in claim 24, wherein the set of prescribed patterns corresponds to a particular sequence of phonemes in the sequence of acoustic observations.

26. The method as defined in claim 24, wherein the set of prescribed patterns corresponds to a particular word or words in the sequence of acoustic observations.

27. The method as defined in claim 24, further comprising:
during the speech recognition processing of each of the separate portions, determining a plurality of prefix nodes that could occur just before the anchor in the sequence of acoustic observations, and determining a plurality of suffix nodes that occur just after the anchor in the sequence, of acoustic observations.

28. The method as defined in claim 27, wherein the prefix nodes and the suffix nodes are determined based on a particular language model.

29. The method as defined in claim 24, wherein the sequence of acoustic observations is a sequence of phonemes or frequency data of a portion of input, speech or a sequence of words.

30. A speech recognition system, comprising:
an input unit for receiving a sequence of acoustic observations;
a pattern detecting unit for detecting at least one occurrence of a set of prescribed patterns occurs in the sequence of acoustic observations;
an anchor setting unit for setting an anchor for at least one of the set of prescribed patterns detected, and for splitting up the sequence of acoustic observations into separate portions separated by the anchor;
a plurality of speech recognition processing units for performing speech recognition processing on each of the separate portions, in parallel; and
a beam intersect determining unit for determining whether or not one beam of nodes corresponding to an output one of the speech recognition processings can be joined with another beam of nodes corresponding to an output of another of the speech recognition processings,
wherein if the determination is that joining can be done, speech recognition information for the one beam is joined with speech recognition information from the another beam, to be used as a combined beam for speech recognition processing to be performed on a remaining portion of the sequence of acoustic observations by at least one of the plurality of speech recognition units.

31. The system as defined in claim 30, wherein the anchor corresponds to a particular word in the sequence of acoustic observations or a particular sequence of phonemes in the sequence of acoustic observations.

32. The system as defined in claim 30, further comprising:
a node beginning and ending determining unit configured determine a plurality of prefix nodes that could occur just before the anchor, and a plurality of suffix nodes that could occur just after the anchor, and to provide that information to the speech recognition processing unit.

33. The system as defined in claim 32, wherein the prefix nodes and the suffix nodes are determined based on a particular language model.

34. A program product having machine-readable program code for performing speech recognition, the program code, when executed, causing a machine to perform the following steps:
receiving a sequence of acoustic observations;
detecting at least one occurrence of a set of prescribed patterns occurs in the sequence of acoustic observations;
based on the detecting result, setting an anchor point for at least one of the set of prescribed patterns detected, and splitting up the sequence of acoustic observations into separate portions separated by the anchor point;
performing a speech recognition processing on each of the separate portions, in parallel;
determining whether or not one beam corresponding to one of the speech recognition processings can be joined with another beam corresponding to another of the speech recognition processings; and
if the determination is that joining can be done, joining speech recognition information for the one beam with speech recognition information from the another beam, to be used as a combined beam for speech recognition processing to be performed on a remaining portion of the sequence of acoustic observations.

35. The program product as defined in claim 34, wherein the set of prescribed patterns corresponds to at least one word in the sequence of acoustic observations or a particular sequence of phonemes in the sequence of acoustic observations.

36. The program product as defined in claim 34, further comprising:
during the speech recognition processing of the at least one of the separate portions, determining a plurality of prefix nodes that could occur just before the anchor in the sequence of acoustic observations, and determining a plurality of suffix nodes that could occur just after the anchor in the sequence of acoustic observations.

37. The program product as defined in claim 34, wherein the prefix nodes and the suffix nodes are determined based on a particular language model.

38. The program product as defined in claim 34, wherein the sequence of acoustic observations is a sequence of phonemes or frequency data of a portion of input speech or a sequence of words.

39. A speech recognition method, comprising:
receiving a set of acoustic observations;
performing a priority queue search on the set of acoustic observations and sorting hypotheses in a priority queue according to a first criterion; and
resorting the hypotheses in the priority queue according to a second criterion different from the first criterion.

40. The speech recognition method according to claim 39, wherein the resorting step is performed based on an estimated expected return on computation for the hypotheses sorted in the sorting step and the hypotheses resorted in the resorting step.

41. A speech recognition system, comprising:
means for sorting hypotheses in a priority queue according to a first criterion, with respect to a set of acoustic observations to be matched against;
means for resorting N highest ranking of the hypotheses in the priority queue according to a second criterion different from the first criterion, wherein N is an integer greater then one; and
means for performing a priority queue search based on the resorted hypotheses in the priority queue.

42. The speech recognition system according to claim 41, further comprising:
processor allocation means for allocating processing time to the sorting means and the resorting means based on an estimated expected return on computation.
